(19) United States
(12) Patent Application Publication
(10) Pub. No.: US 2004/0022989 A1
(43) Pub. Date: Feb. 5, 2004

(54) Packaging surface element with non-adhesive coating and packaging surface with non adhesive coating

(76) Inventor: Hubert Kaffl, Fischbachau (DE)

Correspondence Address: FROMMER LAWRENCE & HAUG, 745 FIFTH AVENUE- 10TH FL., NEW YORK, NY, 10151, US

(21) Appl. No.: 10/392,314

(22) Filed: Mar. 19, 2003

(30) Foreign Application Priority Data
Mar. 20, 2002 (DE) DE 202 04 432.7

(51) Int. Cl. B32B 1/04

(52) U.S. Cl. 428/68

(57) ABSTRACT

The invention relates to a packaging surface element with a non-adhesive coating for an adhesive article or an article containing an adhesive means, as well as a packaging surface with a non-adhesive coating.

The invention relates to a packaging surface unit or a flat packaging element for adhesive goods or goods that contain an adhesive means or is provided with adhesive means.

It is known to manufacture a pouch for receiving solid goods, such that one binds surfaces of a plastic material to one another along a seam, for example, by heat sealing. The plastic material can exist in the form of a packaging surface unit, which is to be folded in the center, so that both halves cover one another. For making a pouch, also two packaging pieces can be provided, which form the two pouch walls. The plastic material has a coating on the side(s) to be sealed made of a heat-sealable material, for example, from polyethylene, polypropylene, Surlyn, or another material. With the use of temperatures of 140° C., for example, the coated sides are bound to one another.

However, all pressure-sealable, adhesive, or heat-sealable materials have the characteristic of adhering very strongly on pressure-sensitive points. This has the result that they also occasionally bind with the goods to be packaged that contain an adhesive means. This is true, in particular, when the goods to be packaged are self-adhesive labels, bandages, or transdermal systems, which are provided with a protective layer over its adhesive layer. They have the common problem that on their edges, which are cut or stamped, adhesive materials or an adhesive, which generally is a pressure-sensitive adhesive, can escape when stored. Depending on the storage conditions, with the consumer or, even with the manufacturer, the adhesive leak can lead to an adhesion of the goods to be packaged with the packaging.

Many bandages, transdermal systems, or labels are provided with a packaging protecting it from environmental effects. Generally, deep-drawn films serve as the packaging, into which the products can be inserted. Subsequently, they are closed with a further film. In the closed packaging means, the product generally is freely moveable, so that the danger of the adhesion of the product with the packaging means is not so great. Much greater, however, is the danger if a pocket or pouch is selected as the packaging means. The product is then exposed to an intensive contact with the pouch inner surface, in particular, when stacked. This leads to an adhesion of the goods to be packaged with the packaging means under certain circumstances or regularly. When the product is removed from the packaging means, this leads to difficulties, whereby in certain cases, the entire product is destroyed.

From the state of the art, solutions are known, in which, respectively, a separating sheet is placed on the products. Or bumps are provided on a protective film, which is adhered to the product, which can be higher than the thickness of the product, in order to reduce the contact with the pouch material; compare, for example, DE 19 902 196, EP 0 405 393 and further, WO 89/04 158, U.S. Pat. No. 2,577,945, U.S. Pat. No. 3,068,860, and U.S. Pat. No. 4,498,586.

The known features have the disadvantage that they are technically expensive and the consumer must either ruin an additional material or the product must be applied on an unnecessarily large protective film. In this regard, each pouch can accommodate far fewer products. In addition, the binding of the product with the protective foil has an inelegant appearance.

It is the object of the pres nt invention to produce a remedy for the above problem.

According to the present invention, this object is solved with a packaging means or packaging surface element of the above-described type, in which the packaging surface element has a non-adhesive coating at least partially or in areas or in zones on the inner side of its wall or on the inner wall.

The non-adhesive coating effectively prevents an adhesion of any adhesive material and, thus, in particular, also the adhesion, for example, of labels, bandages, and transdermal systems. In this regard, it has the particular advantage that they barely apply, and thus, does not reduce the space for the goods to be packaged within the packaging means or packaging surface element. The non-adhesive coating is a fixed component of the packaging means and, accordingly, must be not be removed first by the consumer or user.

Advantageous further embodiments are provided in the dependent claims and in the description.

Particularly advantageous, a packaging surface element has the non-adhesive coating applied proximate to the goods to be packaged or on or above a sealable, for example, pressure- or heat-sealable, coating on the inner wall, and this covers the surfaces that are not to be sealed. The sealable coating can carry the non-adhesive coating. In this manner, the sealing of surfaces is not affected, in order to make pouches or other fixedly connected packaging elements. In addition, only material for the non-adhesive coating is used where it is necessary to prevent adhesion of the packaging goods.

Alternatively, in another likewise preferable variation, the coating is applied between the surfaces of the packaging surface elements to be sealed on the inner wall. In this manner, also the material for making the surfaces to be sealed is used sparingly.

As the material for the non-adhesive coating, silicon is used advantageously. Also, it can operate as a metal vapor deposition.

Alternatively, also a halogenated hydrocarbon polymer can be used for the non-adhesive coating.

The invention also relates to a packaging surface surrounding the packaging surface elements or for the packaging surface elements of the present invention.

In this connection, the present invention also addresses the object of forming the packaging surface, such that it can be easily depackaged from the packaging surface elements made from it.

According to the present invention, this object is solved, in that the distances or spacing of the non-adhesive coatings are marked by recurring reference points or markings or marks, such as, for example, pressure marks.

Preferably, the packaging surface has periodic, recurring marks spaced from the packaging surface elements to be sealed as the marks.

As pressure marks, color or dye marks are particularly suitable.

The non-adhesive coating and/or the pressure- or control marks can be imprinted, whereby rotogravure is preferred, since it offers a satisfactory accuracy.

Next, the invention will be described more specifically in one embodiment with reference to the drawings. In the drawings:

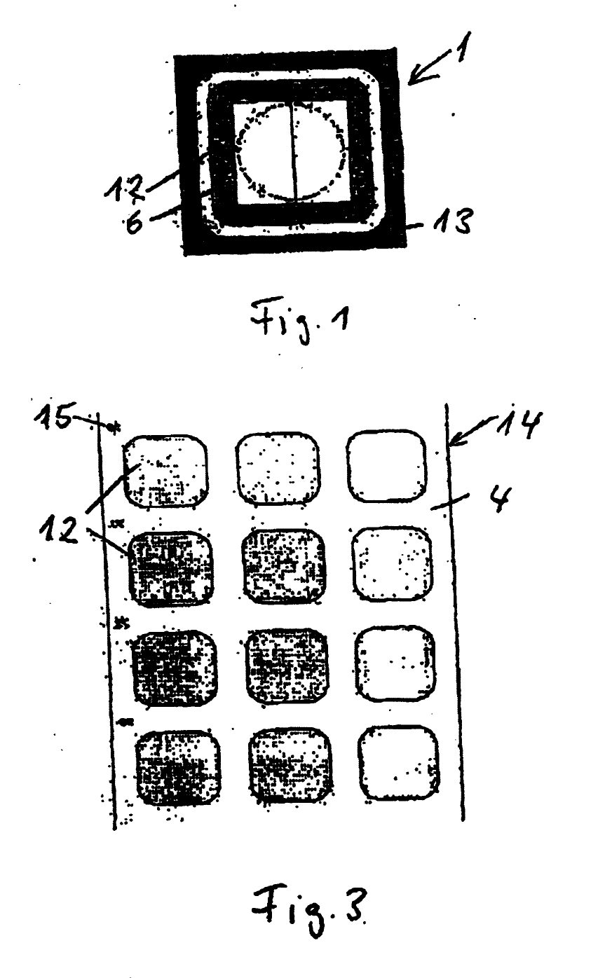

FIG. 1 shows a plan view of a lower packaging surface element for a sealed pouch with a transdermal system applied thereon;

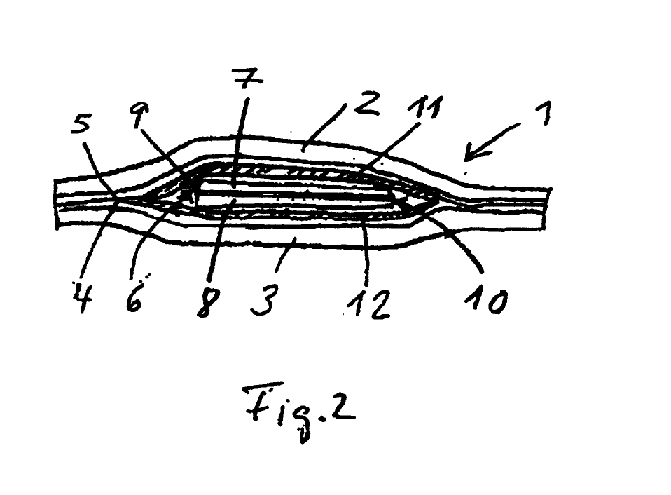

FIG. 2 shows the sealed pouch with the transdermal system according to FIG. 1 in cross section; and

FIG. 3 shows a packaging material with a plurality of non-adhesive coatings in plan view.

A sealed pouch 1 (FIGS. 1, 2) comprises two packaging surfaces connected to one another with their inner sides and has two opposite walls 2, 3, which, respectively, carry a heat-sealable material 4, 5 on their inner sides. The walls 2, 3, comprise a packaging material, for example, paper or cardboard. The coatings 4, 5 contain or comprise, for example, polyethylene, polypropylene, or other heat-sealable materials. With the use of pressure or increased temperatures, for example, in the range of 140° C., the coatings 4, 5, can be connected fixedly to one another, in order to enclose a transdermal system 6 or another type of goods.

The possibility is not excluded that the coatings 4, 5, when they have a sufficient thickness, already form the pouch walls themselves, so that separate walls 2, 3 as the support for the coatings 4, 5 are not required.

The transdermal system 6, which is provided for application to human skin, can have a layer 7 containing an active component and a peelable layer 8, which are connected to one another by an adhesive layer. The layer 7 is provided with a cover layer (not shown). On transverse sides 9, 10 of the transdermal system 6, in disadvantageous cases, adhesive leaks from the adhesive layer, which could adhere with the coatings 4, 5. In order to prevent this kind of adhesion, each of the coatings 4, 5 is provided on its inner side of the sealed pouched 1 with a non-adhesive coating 11, 12. This contains, for example, silicon or a halogenated hydrocarbon.

The coatings 11, 12 can be formed respectively with a layer that can be bound to the coatings 4, 5, which has the characteristic that the adhesion of the goods packaged in the sealed pouch, in the present case, the transdermal system 6, based on the adhesive leaking to the transverse sides 9, 10, is prevented.

The coatings 11, 12 are only applied in the inner region of the sealed pouch 1 on the coatings 4, 5, so that the coatings 4, 5, can combine for forming a circumferential sealing seal that encloses the transdermal system 6.

In an alternative embodiment of the present invention, the coatings 11, 12 are directly applied to the walls 2, 3 of the sealed pouch 1 itself, while the coatings 4, 5, are only applied in the area of the sealing seam 13. In this manner, a heat-sealable material can be spared.

The non-abrasive coating 11 or 12 can be positioned by means of a pressure- or a adhesion method on the inner side of a packing material, that is, for example, of a sheet or a film 14 (FIG. 3), which forms, for example, the packaging material. The manufacturing method is selected, such that the positionings of the coating 12 are exactly determined, and the coating 4 is covered in the region formed by the sealing seam 13 by the coating 12, not with later sealing of the film 14 for making sealed pouches 1.

For achieving exact positions, the film 14 has marks, for example, pressure marks 15, which are applied either on the side facing away from the coating 4 or on the side of the coating 4 itself. As pressure marks 15, color or dye marks are particularly suitable, whose spacing in the longitudinal direction of the processing of the film 14 is as large as the length of the sealed pouch 1.

The pressure- or lacquering work of a pressure machine, with which the coating 12 should be applied, can be positioned precisely, based on the pressure marks 15. The packaging machine, used in a subsequent procedure, with which the sealed pouched 1 is sealed from the film 14, finds the positions of the coating 12 again, when it is equipped with appropriate detectors, based on the pressure marks 15 and then performs the sealing.

### REFERENCE NUMERAL LIST

1 sealed pouch

2 wall of the pouch

3 wall of the pouch

4 sealable coating

5 sealable coating

6 transdermal system

7 layer with active component

8 peelable layer

9 transverse side

10 transverse side

11 non-adhesive coating

12 non-adhesive coating

13 sealed layer, for example, 5 or 2 with 5

14 film

15 markings or pressure marks

1. A packaging surface element for adhesive goods or goods containing adhesive means, characterized in that the packaging surface element has a non-adhesive coating (11, 12) at least partially on its inner wall (2, 3),

2. The packaging surface element according to claim 1, characterized in the non-adhesive coating is applied proximate to the goods to be packaged or on or above a sealable coating (4, 5), in particular, a pressure-sealable or heat-sealable coating on the inner wall (2, 3) and this covers the surfaces that are not to be sealed.

3. The packaging surface element according to claim 1, characterized in that the non-adhesive coating (4, 5) is applied between surfaces to be sealed, in particular, surfaces to be pressure-sealed or heat-sealed, on the inner side of the wall (2, 3).

4. The packaging surface element according to one of claims 1 through 3, characterized by a non-adhesive coating (11, 12) based on silicon or metal.

5. The packaging surface element according to one of claims 1 through 4, characterized by a non-adhesive coating (11, 12) based on at least one halogenated hydrocarbon polymer.

6. The packaging surface with packaging surface elements according to one of the preceding claims, characterized in that the spacings of the non-adhesive coatings (11, 12) are marked by recurring markings or marks, in particular, pressure marks (15).

7. The packaging surface according to claim 6, characterized in that the pressure marks (15) are periodic, recurring marks spaced from the packaging surface element to be sealed.

8. The packaging surface according to claim 7 or 8, characterized in that the pressure marks (15) are color marks.
